(19) United States
(12) Patent Application Publication
(10) Pub. No.: US 2005/0207598 A1
(43) Pub. Date: Sep. 22, 2005

(54) Speaker system

(75) Inventor: Nobuo Fuke, Chiba (JP)

Correspondence Address: Randy J. Pritzker;Wolf, Greenfield & Sacks, P.C., 600 Atlantic Avenue, Boston, MA, 02210-2206, US

(73) Assignee: Sony Corporation, Tokyo (JP)

(21) Appl. No.: 11/016,553

(22) Filed: Dec. 17, 2004

(30) Foreign Application Priority Data
Dec. 17, 2003 (JP) JP2003-419888

(51) Int. Cl. H02B 1/00; H04R 3/00

(52) U.S. Cl. 381/123; 381/99; 381/111

(57) ABSTRACT

In a speaker system having plural speaker units, at least one of the plural speaker units has one resistor for level adjustment that is positioned between terminals of a speaker and a switch for switching connection circuits for connecting the resistor for level adjustment with the speaker. The resistor for level adjustment is connected with the speaker in series or parallel by the switch when performing the level adjustment. The speaker system can get two species of adjustment curves by using one resistor for level adjustment.

### BACKGROUND OF THE INVENTION

1. Field of the Invention

The present invention relates to a speaker system and more particularly, it relates to a speaker system having plural speaker units.

2. Description of Related Art

A speaker for converting an electronic signal to sound waves is the most important portion of reproduction apparatus. A speaker system having plural speaker units has been often utilized in audio equipment.

According to a conventional art, in the speaker system having plural speaker units, in order to adjust respective levels of the speaker units to suitable ones, resistor(s) has (have) generally been connected to a unit having a higher level. Such a configuration of the connection of resistor(s) is illustrated in each of the attached figures, FIGS. 1 to 4.

FIG. 1 shows a configuration of a speaker system having a level adjustment circuit for performing a level adjustment using one resistor. As shown in FIG. 1, a resistor R1 is connected with a speaker S in series. In the circuit shown in FIG.1, a general high-pass filter is formed by using a capacitor C1 and a coil L1. Such the circuit provides one species of adjustment curve (a characteristic curve).

FIG. 2 shows a configuration of another speaker system having a level adjustment circuit for performing a level adjustment using one resistor. As shown in FIG. 2, a resistor R1 is connected with a speaker S in parallel. In the circuit shown in FIG.2, a general high-pass filter is formed by using a capacitor C1 and a coil L1. Such the circuit also provides one species of adjustment curve (a characteristic curve).

FIG. 3 shows a configuration of further speaker system having a level adjustment circuit for performing a level adjustment using two resistors. As shown in FIG. 3, a resistor R1 is connected with a speaker S in parallel and a resistor R2 is connected with the speaker S in series. In the circuit shown in FIG. 3, a general high-pass filter is formed by using a capacitor C1 and a coil L1. Such the circuit provides one species of adjustment curve.

In these cases shown in FIGS. 1 to 3, these circuits and each of the resistance values of the resistors for level adjustment used in the circuits are fixed so that only one species of adjustment curve may be obtained.

Further, FIG. 4 shows a configuration of still-further speaker system having a level adjustment circuit for performing a level adjustment using two resistors. As shown in FIG. 4, resistors R1 and R2 are connected with a speaker S in series by switching a switch. In the circuit shown in FIG. 4, a general high-pass filter is formed by using a capacitor C1 and a coil L1. Such the circuit provides two species of adjustment curves because the resistors R1 and R2 have different values.

Additionally, it has been proposed to provide a speaker system having a power-type resistor-switching adjustment device that uses plural resistors (see page 3 and FIG. 2 of Japanese Utility Model Application Publication No. S56-15531).

In this case, a case made of ceramic material such as porcelain material holds plural resistor elements, and is filled with a heat-resistant compound composed of silicon resin and the like so that it is fixed. An attaching angle to which a switch is fixed is firmly attached to the case through an insulator. Lead lines of the resistor elements are connected to terminals of the switch. Lead lines to a speaker and an amplifier are also connected to the terminals of the switch. These resistor elements are connected with a speaker S in series or parallel depending on a rotation position of an operation axis of the switch. This causes a value of the resistor to be altered so that a suitable amount of speaker input attenuation can be provided. The speaker system can provide at least two species of adjustment curves.

It also has been proposed to provide a speaker system having a speaker attenuator for adjusting volume of a speaker that is connected with an amplifier positioned away from the speaker, at a speaker side (see pages 1 and 3 and FIG. 2 of Japanese Utility Model Application Publication No. S54-180727).

In this case, a switch is composed of first and second changeover switches that are linked with each other. The first changeover switch has a movable terminal being connected with a signal line between the signal line and a transformer and some fixed terminals wherein one fixed terminal is not connected and the other fixed terminals are mutually connected with a terminal of a primary side of the transformer. The second changeover switch has a movable terminal being connected with a speaker and some fixed terminals wherein one fixed terminal is connected with a speaker line via each of the terminals of primary and secondary sides of the transformer and the other fixed terminals are connected with midtaps of the secondary side of the transformer, respectively. In other words, in this case, the connection of the plural resistors is changed over so that they can be connected in series or parallel. The speaker system also can provide at least two species of adjustment curves.

In the case where a user wants to select at least two species of adjustment curves, namely, in cases shown in FIG. 4 and disclosed in the above publications, plural resistors for level adjustment to be used therein are required to alter the adjustment curve by changing a resistance value of the resistors, thereby causing number of parts and the costs therefor to be increased.

An objective of the present invention is to provide a speaker system using one resistor to get two species of adjustment curves, thereby reducing the number of parts to be used and the costs therefor.

### SUMMARY OF THE INVENTION

According to the present invention, the foregoing object is attained by a speaker system having plural speaker units. At least one of the plural speaker units comprises one resistor for level adjustment positioned between terminals of a speaker. The speaker unit also comprises switching device for switching connection circuits each for connecting the resistor for level adjustment with the speaker. Thereby, when performing the level adjustment, the resistor for level adjustment can be connected with the speaker in series or parallel by the switching device.

According to the invention, in the speaker system having plural speaker units, at least one of the plural speaker units comprises one resistor for level adjustment positioned between terminals of the speaker and switching device for switching connection circuits each for connecting the resistor for level adjustment with the speaker, thereby allowing the resistor for level adjustment to be connected with the speaker in series or parallel by the switching device when performing the level adjustment. This allows two species of connection circuits for connecting the resistor for level adjustment with the speaker in series and parallel to be selected, so that the speaker system using one resistor for level adjustment can get two species of adjustment curves. This also allows to be reduced the number of parts to be used and the costs therefor.

In the speaker system, for example, the switching device comprises a jumper wire, thereby allowing the connection circuits to be easily switched and the costs therefor to be reduced.

The concluding portion of this specification particularly points out and directly claims the subject matter of the present invention. However those skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a diagram for showing a configuration of a speaker system using one resistor for level adjustment;

FIG. 2 is a diagram for showing a configuration of another speaker system using one resistor for level adjustment;

FIG. 3 is a diagram for showing a configuration of a speaker system using two resistors for level adjustment;

FIG. 4 is a diagram for showing a configuration of another speaker system using two resistors for level adjustment;

FIG. 5 is a diagram for showing a configuration of a first embodiment of a speaker system according to the invention;

FIGS. 6A to 6C are diagrams each for illustrating an example of arrangement in circuit parts of a speaker system;

FIG. 7 is a table for showing various kinds of the connection states in the speaker system;

FIG. 8 is a graph for indicating characteristic curves of the connection states; and

FIG. 9 is a diagram for showing a configuration of a second embodiment of a speaker system according to the invention.

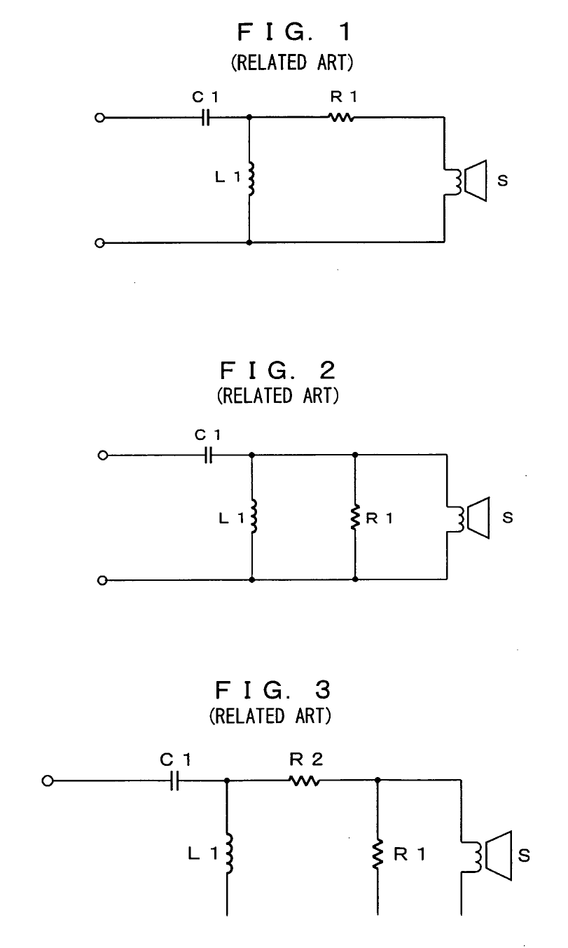

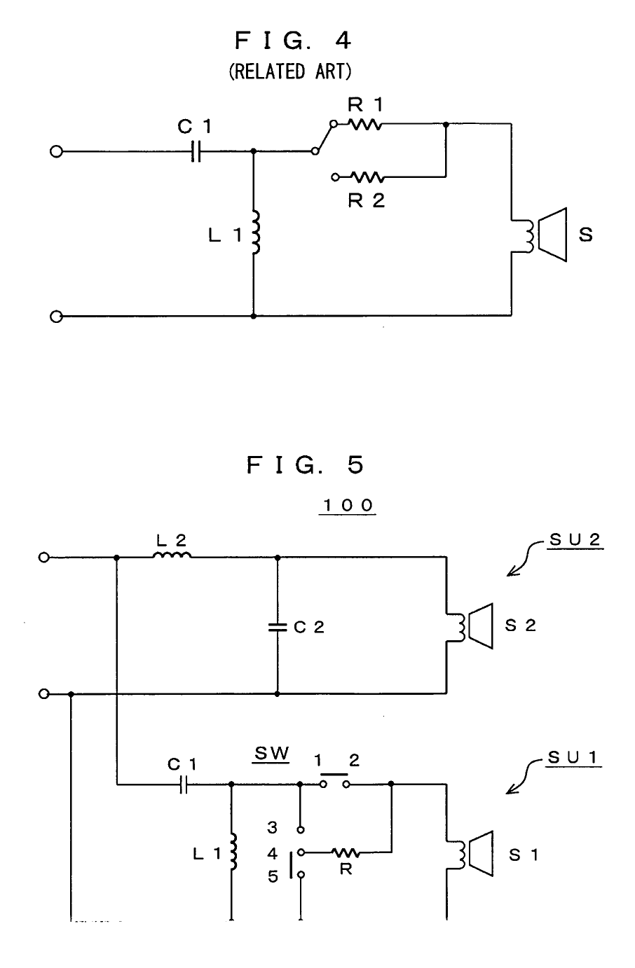

### DETAILED DESCRIPTION OF THE PREFERRED EMBODIMENTS

Hereinafter, speaker systems as embodiments of the present invention will be described with reference to the drawings.

FIG. 5 shows a configuration of a first embodiment of the speaker system 100 according to the invention. As shown in FIG. 1, the speaker system 100 comprises speaker units SU1 and SU2. The speaker unit SU1 comprises a speaker S1, a capacitor C1, a coil L1, a resistor R, a changeover switch SW as switching device. The speaker unit SU2 comprises a speaker S2, a capacitor C2, a coil L2.

In the speaker unit SU1, as shown in FIG. 5, the capacitor C1 is connected with the speaker S1 in series and the coil L1 is connected with the speaker S1 in parallel. In the speaker unit SU2, the capacitor C2 is connected with the speaker S2 in parallel and the coil L2 is connected with the speaker S2 in series. Herein, the capacitor C1 and the coil L1 as well as the capacitor C2 and the coil L2 constitute high-pass filters, respectively.

The resistor R is a resistor for adjusting an input level to the speaker S1. An amount of adjustment maybe altered based on volumes of a resistance value of the resistor R. The resistor R has an end being connected with an end (at a side of terminal 2 of the switch SW) of the speaker S1 and the other end being connected with a connecting terminal 4 of the switch SW, which can be connected to a terminal 3 or 5 of the switch SW. Terminals 1 and 2 of the switch SW can be also connected with each other.

If the terminals 1 and 2 are connected and the terminal 4 is not connected with the terminal 3 nor 5, the resistor R fails to make a connection to the speaker S1. If the terminals 1 and 2 are not connected and the terminal 4 is connected with the terminal 3, the resistor R is connected with the speaker S1 in series. If the terminals 1 and 2 are connected and the terminal 4 is connected with the terminal 5, the resistor R is connected with the speaker S1 in parallel.

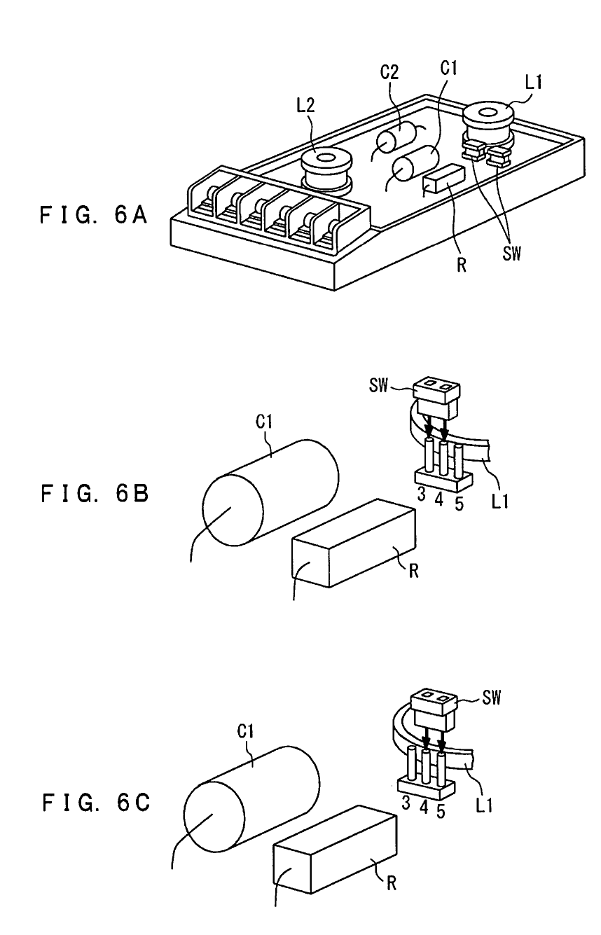

The changeover switch SW is composed of a jumper wire, for example. FIGS. 6A to 6C illustrate an example of arrangement in circuit parts of a speaker system 100. FIG. 6A is a perspective view of the arrangement in circuit parts of a speaker system 100. FIG. 6B is a schematic view for showing a case where the terminals 3 and 4 of the switch SW are connected using the jumper wire. FIG. 6C is a schematic view for showing a case where the terminals 4 and 5 of the switch SW are connected using the jumper wire. As shown in FIGS. 6B and 6C, a case where the terminals 3 and 4 are connected is altered to a case where the terminals 4 and 5 are connected according to a lateral shift of the switch SW so that the connection circuits for connecting the resistor R for level adjustment to the speaker S1 can be switched.

In the speaker system 100, when performing adjustment of input level to the speaker S1, at a first normal connection state, the terminals 1 and 2 are connected and the terminal 4 is not connected with the terminal 3 nor 5. The switch SW is then switched so that the terminals 1 and 2 are not connected and the terminal 4 is connected with the terminal 3, to switch the connection circuits for connecting the resistor R to the speaker S1. Alternatively, the switch SW is switched so that the terminals 1 and 2 are connected and the terminal 4 is connected with the terminal 5, to switch the connection circuits for connecting the resistor R to the speaker S1. This allows the speaker system to be made level adjustment by connecting the resistor R to the speaker in series or parallel.

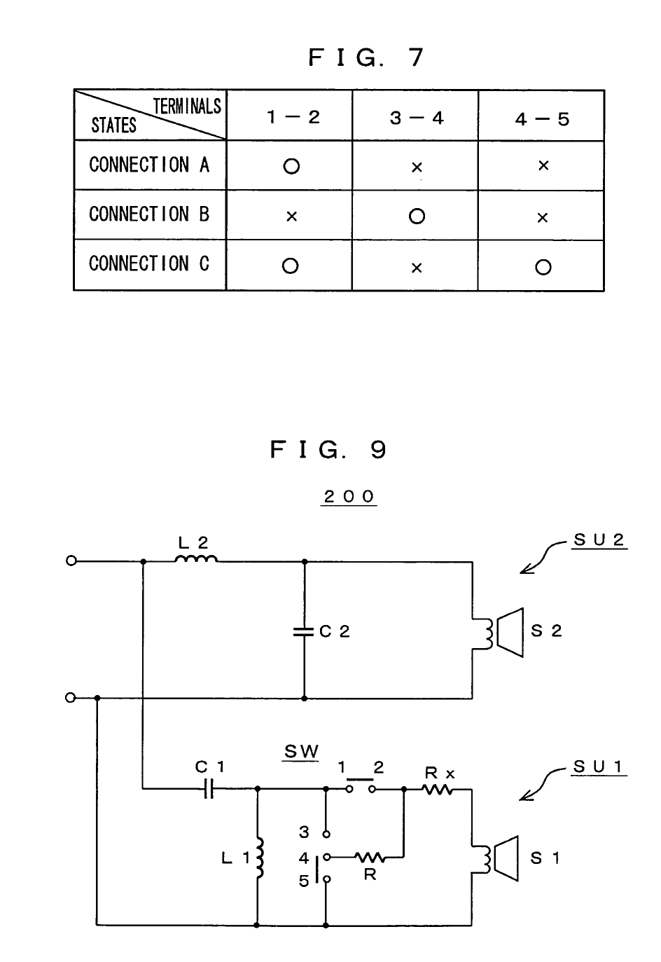

FIG. 7 is a table for showing various kinds of the connection states of the terminals of the switch SW in the speaker unit SU1. As shown in FIG. 7, a connection state A indicates a state where the terminals 1 and 2 are connected. In this case, based on switching of the switch SW, the terminal 4 is not connected with the terminal 3 nor 5. As a result thereof, the resistor R is not connected with the speaker S1, thereby failing to perform a level adjustment.

A connection state B indicates a state where, according to the switching of the switch SW, the terminals 1 and 2 are then not connected and the terminal 4 is connected with the terminal 3, not 5. As a result thereof, the resistor R is connected with the speaker S1 in series.

A connection state C indicates a state where, according to the further switching of the switch SW, the terminals 1 and 2 are connected and the terminal 4 is connected with the terminal 5, not 3. As a result thereof, the resistor R is connected with the speaker S1 in parallel.

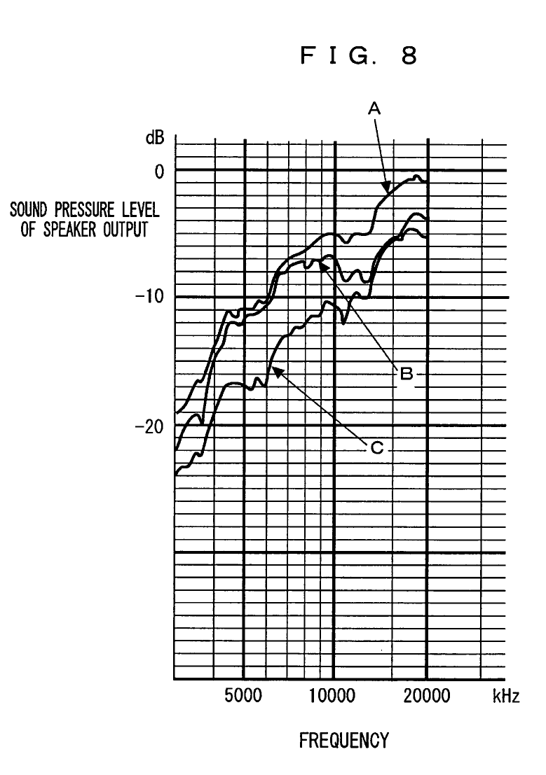

FIG. 8 is a graph for indicating characteristic curves of the connection states A to C. In FIG. 8, a vertical axis indicates sound pressure level of output from the speaker S1. A horizontal axis therein indicates a frequency. Measurements of characteristics were performed to get the characteristic curves under the condition where values of the capacitor C1 and the coil L1 are fixed and a resistance value in the connection circuit is altered by switching the connection circuits for connecting the resistor R to the speaker S1.

In the characteristic curves shown in FIG. 8, curve A indicates a characteristic of a circuit of the speaker unit SU1 in the connection state A before a level adjustment by the resistor R has been performed. Namely, this indicates a characteristic of the circuit when the resistor R has not been connected with any connection circuits in the speaker unit SU1. Curve B indicates an adjustment curve in the connection state B when the resistor R is connected with the speaker S1 in series. Curve C indicates an adjustment curve in the connection state C when the resistor R is connected with the speaker S1 in parallel. Thus, switching the connection circuits of the resistor R to the speaker S1 allows two species of the different adjustment curves to be obtained. This permits to be implemented the level adjustment between the speaker units SU1 and SU2.

According to this embodiment, in the speaker system 100, one speaker unit SU1 of the two speaker units SU1 and SU2 comprises one resistor R for level adjustment and the changeover switch SW for switching the connection circuits of the resistor R to the speaker S1, thereby connecting the resistor R for level adjustment with the speaker S1 in series or parallel by using the switch SW.

In this condition, the terminals 1 and 2 are connected and the terminal 4 is not connected with the terminal 3 nor 5. As a result thereof, the resistor R is not connected with any circuits in the speaker unit SU1, thereby failing to perform a level adjustment. The terminals 1 and 2 are then not connected and the terminal 4 is connected with the terminal 3, not 5, so that the resistor R is connected with the speaker S1 in series, thereby allowing a level adjustment to be implemented. Further, the terminals 1 and 2 are connected and the terminal 4 is connected with the terminal 5, not 3, so that the resistor R is connected with the speaker S1 in parallel, thereby another level adjustment to be implemented.

Thus, since two species of the connection circuits for connecting the resistor R to the speaker S1 in series and parallel are selected, two species of adjustment curves can be obtained by using one resistor. This allows to be reduced the number of parts to be used and the costs therefor. Further, using the changeover switch SW made of the jumper wire allows the connection circuits to be easily switched and the costs therefor to be suppressed.

FIG. 9 shows a configuration of a second embodiment of a speaker system 200 according to the invention. As shown in FIG. 9, the speaker system 200 has speaker units SU1 and SU2. The speaker unit SU1 comprises a speaker S1, a capacitor C1, a coil L1, a resistor R, a resistor Rx, and a changeover switch SW as switching device. The speaker unit SU2 comprises a speaker S2, a capacitor C2, and a coil L2.

The speaker system 200 corresponds to a system such that the resistor Rx is added to the speaker system 100. The resistor Rx is set for matching an output level from the speaker unit SU1 to that from the speaker unit SU2.

Thus, in the speaker system 200 of this embodiment, one speaker unit SU1 of the speaker units SU1 and SU2 comprises one resistor R for level adjustment and the changeover switch SW for switching the connection circuits of the resistor R to the speaker S1 so that by the changeover switch SW, the resistor R for level adjustment can be connected with the speaker S1 in series or parallel. Further, the resistor Rx for matching an output level from the speaker unit SU1 to that from the speaker unit SU2 is also set therein.

This allows two species of connection circuits for connecting the resistor R for level adjustment with the speaker S1 in series and parallel to be selected, so that the speaker system using one resistor for level adjustment can get two species of adjustment curves. This allows to be reduced the number of parts to be used and the costs therefor. In the speaker system 200, the changeover switch SW made of a jumper wire is also used, thereby allowing the connection circuits to be easily switched and the costs therefor to be reduced. This also allows output levels from the speaker units SU1 and SU2 to be easily matched.

Note that although it has been described in the above embodiments that the changeover switch SW is made of a jumper wire, the invention is not limited to this. In the invention, other changeover switch can be used.

Note also that although it has been described in the above embodiments that the speaker systems 100 and 200 have two speaker units, the invention is not limited to this. The invention can be applied to a speaker system having more than two speaker units.

While the foregoing specification has described preferred embodiment(s) of the present invention, one skilled in the art may make many modifications to the preferred embodiment without departing from the invention in its broader aspects. The appended claims therefore are intended to cover all such modifications as fall within the true scope and spirit of the invention.

1. A speaker system having plural speaker units, at least one of the plural speaker units comprising:
one resistor for level adjustment positioned between terminals of a speaker; and
switching device for switching connection circuits each for connecting the resistor for level adjustment with the speaker, thereby allowing the resistor for level adjustment to be connected with the speaker in any one of series and parallel by the switching device when performing the level adjustment.

2. The speaker system according to claim 1, wherein said switching device comprises a jumper wire.
